(19) United States
(12) Patent Application Publication
(10) Pub. No.: US 2013/0304308 A1
(43) Pub. Date: Nov. 14, 2013

(54) VEHICLE INFORMATION ACQUISITION DEVICE AND VEHICLE INFORMATION ACQUISITION METHOD

(71) Applicants: Yousuke Maruyama, Nagaoka (JP); Nobuaki Kobayashi, Nagaoka (JP)

(72) Inventors: Yousuke Maruyama, Nagaoka (JP); Nobuaki Kobayashi, Nagaoka (JP)

(73) Assignee: NIPPON SEIKI CO., LTD., Nagaoka, Niigata (JP)

(21) Appl. No.: 13/981,845

(22) PCT Filed: Jan. 12, 2012
(86) PCT No.: PCT/JP2012/050439

§ 371 Date: Jul. 25, 2013

(30) Foreign Application Priority Data
Jan. 25, 2011 (JP) 2011-012474

(51) Int. Cl. G06F 17/00

(52) U.S. Cl. CPC G06F 17/00
USPC 701/31.4

(57) ABSTRACT

Provided are a vehicle information acquisition device and a vehicle information acquisition method which are capable of accelerating the update time of vehicle information that needs to be updated in a short time and enhancing convenience. A vehicle information acquisition device (200) transmits respective pieces of request data each requesting any one of multiple kinds of vehicle information in a predetermined order via a vehicle diagnosis connector (302) provided in a vehicle (300) and receives, from the vehicle (300) side, respective pieces of response data indicating the respective pieces of vehicle information to thereby periodically acquire the respective pieces of vehicle information. The vehicle information acquisition device is characterized by transmitting, among the respective pieces of request data, request data that requests vehicle information having a higher update priority at a higher frequency than request data that requests vehicle information having a lower update priority.

### TECHNICAL FIELD

The present invention relates to a vehicle information acquisition device and vehicle information acquisition method for periodically acquiring vehicle information, such as vehicle speed, engine speed, accelerator opening, intake pressure, water temperature and outside air temperature, through a vehicle diagnosis connector provided in a vehicle.

### BACKGROUND ART

A conventional example of a vehicle information display device for acquiring vehicle information from a vehicle-side ECU (electronic control unit) through a vehicle diagnosis connector, such as OBD2 (on-board diagnostics 2), provided in a vehicle and displaying the acquired information is disclosed in PTL 1.

### CITATION LIST

### Patent Literature

PTL 1: JP-A-2008-49731

### SUMMARY OF INVENTION

### Technical Problem

However, conventional methods for acquiring vehicle information through a vehicle diagnosis connector has a problem of taking time to update vehicle information data in attempting to acquire a plurality of types of vehicle information. Specifically, in order to acquire vehicle information from a vehicle-side ECU through the vehicle diagnosis connector, it is necessary to perform processing of sending a data frame (hereinafter also referred to as a request data) requesting one type of vehicle information from a vehicle information acquisition side to the vehicle-side ECU by, for example, CAN (controller area network) communication and receiving a data frame (hereinafter also referred to as a response data) giving the requested type of vehicle information from the vehicle-side ECU. Due to this, it is impossible to update a plurality of types of vehicle information at the same time. In order to acquire a plurality of types of vehicle information, it is necessary to send a plurality of request data requesting respective types of vehicle information in order and receive the respective response data. Thus, in attempting to display a plurality of types of vehicle information at the same time, since updating vehicle information data takes time, engine speed, intake pressure, throttle opening and the like, the numeric value of which changes rapidly and requires fast updating, cannot be smoothly displayed.

In view of the above problem, it is an object of the present invention to provide a vehicle information acquisition device and vehicle information acquisition method for acquiring a plurality of types of vehicle information through a vehicle diagnosis connector, capable of reducing update time of vehicle information that needs to be updated in a short time to enhance convenience.

### Solution to Problem

In order to solve the above-described problem, the invention provides

a vehicle information acquisition device for sending a plurality of request data in a predetermined order each requesting any one of a plurality of vehicle information through a vehicle diagnosis connector provided in a vehicle and receiving a plurality of response data giving the respective types of vehicle information from the vehicle-side, thereby periodically acquiring the respective types of vehicle information,

wherein, among the plurality of request data, the request data that requests vehicle information having a higher update priority is sent more frequently than the request data that requests vehicle information having a lower update priority.

In order to solve the above-described problem, the invention provides

a vehicle information acquisition method for sending a plurality of request data in a predetermined order each requesting any one of a plurality of vehicle information through a vehicle diagnosis connector provided in a vehicle and receiving a plurality of response data giving the respective types of vehicle information from the vehicle-side, thereby periodically acquiring the respective types of vehicle information,

wherein, among the plurality of request data, the request data that requests vehicle information having a higher update priority is sent more frequently than the request data that requests vehicle information having a lower update priority.

### Advantageous Effect of Invention

According to the invention, a vehicle information acquisition device that acquires a plurality of types of vehicle information through a vehicle diagnosis connector can reduce the update time of vehicle information that needs to be updated in a short time, thereby enhancing convenience.

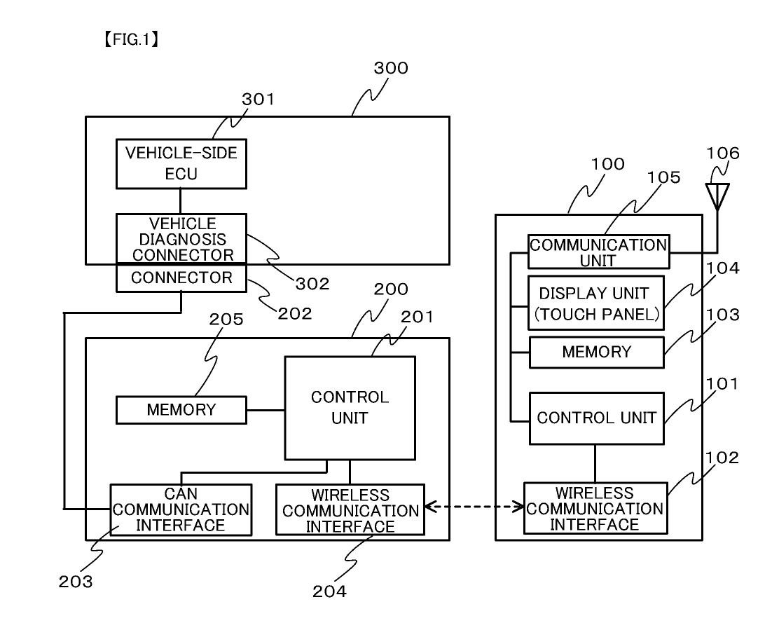

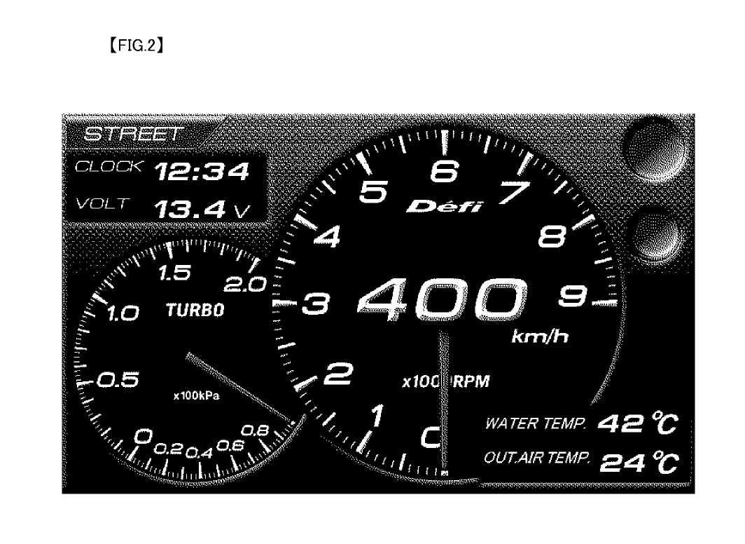

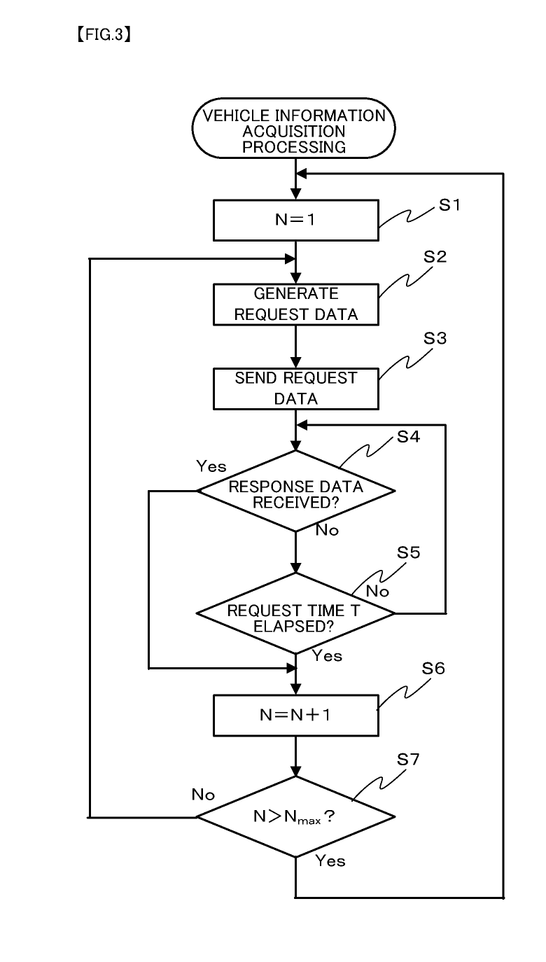

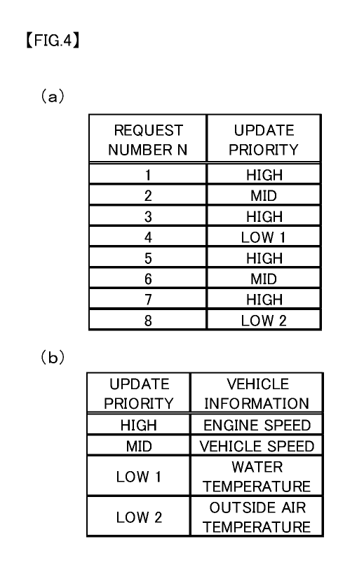

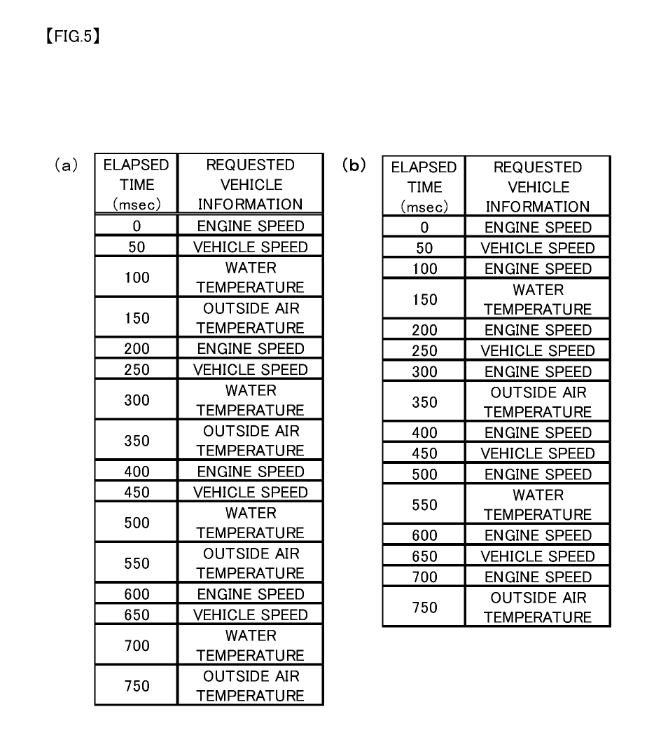

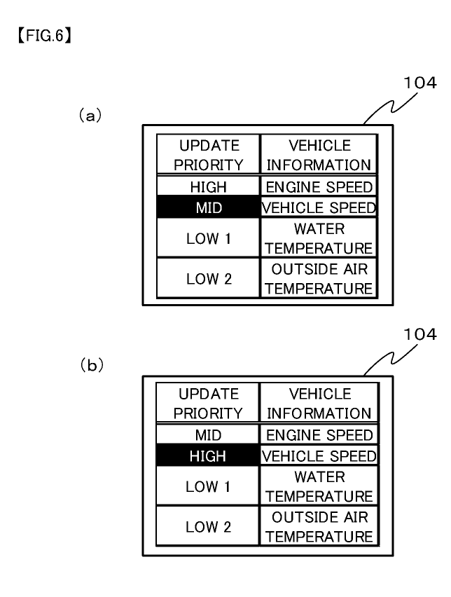

### BRIEF DESCRIPTION OF DRAWINGS

[FIG. 1] A block diagram showing a configuration of a vehicle information display system in accordance with an embodiment of the invention.

[FIG. 2] A diagram showing a display example on a display unit of a mobile phone in accordance with the embodiment.

[FIG. 3] A flowchart showing a vehicle information acquisition method in accordance with the embodiment.

[FIG. 4] A diagram showing a data table to be referred to in the vehicle information acquisition method in accordance with the embodiment.

[FIG. 5] A diagram showing a relation between the elapsed time and the requested vehicle information in the vehicle information acquisition method in accordance with the embodiment and a relation between the elapsed time and the requested vehicle information in a conventional vehicle information acquisition method.

[FIG. 6] A diagram showing a display example on the display unit of the mobile phone in accordance with the embodiment.

### DESCRIPTION OF EMBODIMENTS

A first embodiment in accordance with the invention is described below with reference to the drawings. It should be noted that the invention is not limited to the following embodiment (including the drawings). Also, it should be appreciated that modification (including removing a component) may be made to the following embodiment. Furthermore, it should be noted that, in the following description, the description of known technical matters is appropriately omitted in order to facilitate understanding of the invention.

FIG. 1 shows a configuration of a vehicle information display system in accordance with the embodiment. The vehicle information display system includes a mobile phone (an example of external equipment) 100 and a vehicle information acquisition device 200. The mobile phone 100 and the vehicle information acquisition device 200 are wirelessly connected to enable communication with each other. The mobile phone 100 and the vehicle information acquisition device 200 may also be connected by wire. The vehicle information acquisition device 200 acquires vehicle information from a vehicle-side ECU 301 through a vehicle diagnosis connector 302 provided in a vehicle 300. Acquired vehicle information includes, but not limited to, vehicle speed, engine speed, throttle opening, water temperature, intake pressure, outside air temperature and voltage. The vehicle-side ECU 301 includes a power train-related ECU for engine control and the like and a body-related ECU for air conditioner control and the like. In the embodiment, the vehicle diagnosis connector 302 includes an OBD2 female connector and performs CAN communication between the vehicle-side ECU 301 and the vehicle information acquisition device 200. The communication between the vehicle-side ECU 301 and the vehicle information acquisition device 200 may also be performed through K-LINE.

The mobile phone 100 includes a control unit 101 including a microcomputer, a wireless communication interface 102, a memory 103, a display unit 104, a communication unit 105 and an antenna unit 106. The wireless communication interface 102 uses a short distance wireless communication method, such as Bluetooth (TM) and wireless LAN. The display unit 104 is a display including a touch panel, performs image displaying and also works as an operation unit for application execution and the like. The mobile phone 100 in the embodiment is an intelligent mobile phone called smartphone, and stores a plurality of types of applications in the control unit 101. So, the mobile phone 100 has various functions, including conversation, email, navigation, music data reproduction, picture data reproduction, moving picture data reproduction, map displaying and web-browsing, that are started when the applications are executed by the control unit 101. Furthermore, in the embodiment, the mobile phone 100 includes an application for performing vehicle information display function for displaying vehicle information described later. The display unit 104 of the mobile phone 100 displays an image relating to the application being executed.

The vehicle information acquisition device 200 includes a control unit 201 including a microcomputer, a connector 202, a CAN communication interface 203, a wireless communication interface 204 and a memory 205. The connector 202 is a connector that can be connected to the vehicle diagnosis connector 302 provided in the vehicle 300. In the embodiment, the connector 202 includes an OBD2 male connector having wirings including a +12V continuous power supply line, a CAN _H signal line, a CAN_L signal line and a ground line. The CAN communication interface 203 is an interface for performing CAN communication with the vehicle-side ECU 301 through the vehicle diagnosis connector 302. The wireless communication interface 204 is an interface for wirelessly connecting with the mobile phone 100 and uses a standard similar to the one used by the wireless communication interface 102. The memory 205 stores vehicle information acquired from the vehicle-side ECU 301, a data table described later and the like.

In the vehicle information display system, when the mobile phone 100 and the vehicle information acquisition device 200 are connected to each other, their respective control units 101 and 201 recognize the connection through their respective wireless communication interfaces 102 and 204. When the control unit 101 of the mobile phone 100 recognizes the connection with the vehicle information acquisition device 200, the control unit 101 becomes able to receive vehicle information from the vehicle information acquisition device 200. At this time, the application for performing the vehicle information display function may be automatically or manually started. The control unit 201 of the vehicle information acquisition device 200 sends vehicle information acquired using a method described later to the mobile phone 100 through the wireless communication interface 204. FIG. 2 shows a display example on the display unit 104 of the vehicle information display function. In FIG. 2, for vehicle information, engine speed and intake pressure are displayed in respective analog meter images each including a needle and index part, while vehicle speed, water temperature, outside air temperature and voltage are digitally displayed. For another information, time is digitally displayed.

Next, a vehicle information acquisition method using the vehicle information acquisition device 200 is described with reference to FIG. 3. The following description takes an example of acquiring four types of vehicle information including engine speed, vehicle speed, water temperature and outside air temperature.

When powered on, the control unit 201 of the vehicle information acquisition device 200 initializes the request number N to 1 (step S1).

Then, the control unit 201 generates a data frame (request data) for requesting one type of vehicle information from the vehicle-side ECU 301 (step S2). The vehicle information requested by the request data is specified with reference to a data table stored in the memory 205. As shown in FIG. 4, the data table includes a data table containing the request number N and the update priority of vehicle information (FIG. 4(a)) and a data table containing the type of vehicle information and the update priority (FIG. 4(b)). Thus, the generated request data requests vehicle information according to the request number N and the update priority. For example, according to FIG. 4, the first request data (N=1) requests engine speed from the vehicle-side ECU 301. Furthermore, the data table shown in FIG. 4(a) is configured such that vehicle information having a higher update priority is more frequently requested than vehicle information having a lower update priority (“HIGH” update priority means a frequency higher than “MID,” “LOW-1” and “LOW-2.” “MID” update priority means a frequency higher than “LOW-1” and “LOW-2.” “LOW-1” update priority means the same frequency as “LOW-2”). Specifically, in the data table, “MID,” “LOW-1” and “LOW-2” update priorities are inserted between successive “HIGH” update priorities in a nested manner.

Next, the control unit 201 sends the request data generated in the step S2 from the CAN communication interface 203 to the vehicle-side ECU 301 through the vehicle diagnosis connector 302 (step S3). The request data is sent to a bus line (not shown) in the vehicle and received by the vehicle-side ECU 301. On receiving the request data, the vehicle-side ECU 301 sends a data frame (response data) giving the type of vehicle information requested by the request data to the bus line. The response data sent to the bus line is received by the control unit 201 through the vehicle diagnosis connector 302 and the CAN communication interface 203, then the control unit 201 acquires the type of vehicle information.

Next, the control unit 201 determines whether or not the control unit 201 has received the response data (step S4). If the control unit 201 has not received the response data (step S4: NO), then the control unit 201 further determines whether or not a predetermined request time T (e.g., 50 msec) has elapsed since the sending of the request data (step S5). If the request time T has elapsed (step S5: YES), the control unit 201 increments the request number N (N=N+1, step S6). If the request time T has not elapsed (step S5: NO), the control unit 201 returns to the step S4 and determines again whether or not the control unit 201 has received the response data.

If the control unit 201 has received the response data in the step S4 (step S4: YES), the control unit 201 increments the request number N (N=N+1, step S6).

Next, the control unit 201 determines whether or not the request number N has exceeded the maximum value Nmax (Nmax=8 in FIG. 4) (step S7). If the request number N is equal to or less than the maximum value Nmax (N Nmax, step S7: NO), the control unit 201 returns to the step S2. If the request number N has exceeded the maximum value Nmax (N>Nmax, step S7: YES), the control unit 201 returns to the step S1 to initialize the request number N to 1, then performs processing in the step S2 and later.

The control unit 201 repeats the above-described processing until the power is turned off to periodically acquire the four types of vehicle information including engine speed, vehicle speed, water temperature and outside air temperature. According to the above vehicle information acquisition method, referring to a duration in which the acquisition of the four types of vehicle information completes as one period, the request data that requests vehicle information having a higher update priority is more frequently sent than the request data that requests vehicle information having a lower update priority within one period. Specifically, the sending of the request data that request vehicle information having “MID,” “LOW-1” and “LOW-2” update priorities is inserted in a predetermined order in a nested manner between the successive sending of the request data that request vehicle information having “HIGH” update priority.

FIG. 5 shows a relation between the elapsed time and the vehicle information which the request data is sent for (requests) according to a conventional vehicle information acquisition method (FIG. 5(a)) and a relation between the elapsed time and the vehicle information which the request data is sent for according to the vehicle information acquisition method according to the embodiment (FIG. 5(b)). Note that, in the case shown in FIG. 5, the request data is sent each time the request time T (T=50 msec) elapses.

As shown in FIG. 5(a), according to the conventional vehicle information acquisition method, since the request data for the four types of vehicle information are sent in order, the update time of each type of vehicle information (the interval in which the request data is sent) is 200 msec each. On the other hand, as shown in FIG. 5(b), according to the vehicle information acquisition method according to the embodiment, any of three update priorities (HIGH, MID, LOW) is assigned to the four types of vehicle information, specifically, “HIGH” is assigned to engine speed, “MID” is assigned to vehicle speed, and “LOW” is assigned to water temperature and outside air temperature, and the frequency at which the request data is sent in the duration in which the acquisition of the four types of vehicle information completes depends on the type of vehicle information. Due to this, the update time of the four types of vehicle information is not constant. Specifically, the update time of engine speed having “HIGH” update priority is 100 msec, the update time of vehicle speed having “MID” update priority is 200 msec, and the update time of water temperature and outside air temperature having “LOW” update priority is 400 msec. Thus, the update time of engine speed, the numeric value of which changes rapidly, can be reduce to half in comparison with using the conventional vehicle information acquisition method. On the other hand, the update time of water temperature and outside air temperature having “LOW” update priority is increased twice in comparison with using the conventional vehicle information acquisition method. However, since these vehicle information do not change so rapidly as engine speed and vehicle speed, there is no problem with the increased update time. That is, noting the fact that some types of vehicle information need to be updated in a short time and other types of vehicle information do not need to be updated in a short time depending on the characteristics of vehicle information, the invention provides different update priorities depending on the characteristics and sends the response data at different frequencies to optimize data updating.

In the vehicle information acquisition method using the vehicle diagnosis connector 302, a certain amount of time is taken from the sending of the request data to the receiving of the response data, the amount of time varying depending on car model. The problem is that, when the next request data is sent only after the response data is received, actual update time of vehicle information may be longer than a predetermined update time. In view of this problem, in the embodiment, if the response data is received (step S4: YES) or if the predetermined request time T has elapsed since the sending of the request data (step S5: YES), the process returns to the step S2 to send the next request data (step S3). This can further reduce the update time of vehicle information when the response data is received before the request time T elapses, or can maintain a desired update time even when the response data is received after the request time T elapses, which can enhance convenience.

Furthermore, the vehicle information acquisition device 200 may also have an update priority setting function for switching update priorities set for individual types of vehicle information. In the embodiment, for example, the types of vehicle information and their respective update priorities are displayed on the display unit 104 of the mobile phone 100, then the update priorities are changed by touch panel operation, then the changing data is sent to the vehicle information acquisition device 200 through the wireless communication interface 102, and then the data table (FIG. 4(b)) stored in the memory 205 is rewritten, thereby achieving the update priority setting function. FIG. 6 shows a display example on the display unit 104 of the update priority setting function. In the embodiment, the number of the update priorities is fixed such that “HIGH” is assigned to one type, “MID” is assigned to one type, and “LOW” is assigned to two types, so the changing of the update priorities is performed among four types of vehicle information. In FIG. 6, the update priority of vehicle speed is changed from “MID” (FIG. 6(a)) to “HIGH” (FIG. 6(b)). At this time, the update priority of engine speed is changed from “HIGH” to “MID.” According to this function, a user can freely change the update time of vehicle information according to the user's preference or vehicle management need, which can further enhance marketability or functionality.

The embodiment has been described in connection with the acquisition of four types of vehicle information including engine speed, vehicle speed, water temperature and outside air temperature. However, it should be appreciated that the invention may also be applied to the acquisition of five or more types of vehicle information. Examples of vehicle information that needs to be updated in a short time other than engine speed includes throttle opening and intake pressure. In this case, there may be a plurality of types of vehicle information having “HIGH” update priority.

The vehicle information acquisition device 200 sends acquired vehicle information to the mobile phone 100. However, the vehicle information acquisition device 200 may also send vehicle information to a dedicated display device or navigation device, a tablet device or portable internet device similar to a mobile phone, a PDA (personal digital assistant) or the like as the external equipment. Also, the vehicle information acquisition device 200 may be integrated with a display means that can display vehicle information in one case to form a vehicle information display device and may send vehicle information to the display means.

### INDUSTRIAL APPLICABILITY

The invention is suitable for a vehicle information acquisition device and vehicle information acquisition method for periodically acquiring vehicle information, such as vehicle speed, engine speed, accelerator opening, intake pressure, water temperature and outside air temperature, through a vehicle diagnosis connector provided in a vehicle.

### REFERENCE SIGNS LIST

100 mobile phone
101 control unit
102 wireless communication interface
103 memory
104 display unit
105 communication unit
106 antenna unit
200 vehicle information device
201 control unit
202 connector
203 CAN communication interface
204 wireless communication interface
205 memory
300 vehicle
301 vehicle-side ECU
302 vehicle diagnosis connector

### FIG. 1

301 VEHICLE-SIDE ECU
302 VEHICLE DIAGNOSIS CONNECTOR
202 CONNECTOR
205 MEMORY
203 CAN COMMUNICATION INTERFACE
201 CONTROL UNIT
204 WIRELESS COMMUNICATION INTERFACE
105 COMMUNICATION UNIT
104 DISPLAY UNIT (TOUCH PANEL)
103 MEMORY
101 CONTROL UNIT
102 WIRELESS COMMUNICATION INTERFACE

### FIG. 3

### VEHICLE INFORMATION ACQUISITION PROCESSING

S2 GENERATE REQUEST DATA
S3 SEND REQUEST DATA
S4 RESPONSE DATA RECEIVED?
S5 REQUEST TIME T ELAPSED?

### FIG. 4

(A)

| | |
|---|---|
| REQUEST NUMBER N | UPDATE PRIORITY |

HIGH
MID
HIGH
LOW-1
HIGH
MID
HIGH
LOW-2

(B)

| UPDATE PRIORITY | VEHICLE INFORMATION |
|---|---|
| HIGH | ENGINE SPEED |
| MID | VEHICLE SPEED |
| LOW-1 | WATER TEMPERATURE |
| LOW-2 | OUTSIDE AIR TEMPERATURE |

### FIG. 5

(A)

| ELAPSED TIME (msec) | REQUESTED VEHICLE INFORMATION |
|---|---|
| | ENGINE SPEED |
| | VEHICLE SPEED |
| | WATER TEMPERATURE |
| | OUTSIDE AIR TEMPERATURE |
| | ENGINE SPEED |
| | VEHICLE SPEED |
| | WATER TEMPERATURE |
| | OUTSIDE AIR TEMPERATURE |
| | ENGINE SPEED |
| | VEHICLE SPEED |
| | WATER TEMPERATURE |
| | OUTSIDE AIR TEMPERATURE |
| | ENGINE SPEED |
| | VEHICLE SPEED |
| | WATER TEMPERATURE |
| | OUTSIDE AIR TEMPERATURE |

(B)

| ELAPSED TIME (msec) | REQUESTED VEHICLE INFORMATION |
|---|---|
| | ENGINE SPEED |
| | VEHICLE SPEED |
| | ENGINE SPEED |
| | WATER TEMPERATURE |
| | ENGINE SPEED |
| | VEHICLE SPEED |
| | ENGINE SPEED |
| | OUTSIDE AIR TEMPERATURE |
| | ENGINE SPEED |
| | VEHICLE SPEED |
| | ENGINE SPEED |
| | WATER TEMPERATURE |
| | ENGINE SPEED |
| | VEHICLE SPEED |
| | ENGINE SPEED |
| | OUTSIDE AIR TEMPERATURE |

### FIG. 6

(A)

| UPDATE PRIORITY | VEHICLE INFORMATION |
|---|---|
| HIGH | ENGINE SPEED |
| MID | VEHICLE SPEED |
| LOW-1 | WATER TEMPERATURE |
| LOW-2 | OUTSIDE AIR TEMPERATURE |

(B)

| UPDATE PRIORITY | VEHICLE INFORMATION |
|---|---|
| MID | ENGINE SPEED |
| HIGH | VEHICLE SPEED |
| LOW-1 | WATER TEMPERATURE |
| LOW-2 | OUTSIDE AIR TEMPERATURE |

1. A vehicle information acquisition device for sending a plurality of request data in a predetermined order each requesting any one of a plurality of vehicle information through a vehicle diagnosis connector provided in a vehicle and receiving a plurality of response data giving the respective types of vehicle information from the vehicle-side, thereby periodically acquiring the respective types of vehicle information,
wherein, among the plurality of request data, the request data that requests vehicle information having a higher update priority is sent more frequently than the request data that requests vehicle information having a lower update priority.

2. The vehicle information acquisition device according to claim 1, wherein, when the response data is received or when a predetermined time has elapsed since the sending of the request data, the next request data is sent.

3. The vehicle information acquisition device according to claim 1, comprising an update priority setting function for changing the update priorities.

4. The vehicle information acquisition device according to claim 1, wherein the acquired vehicle information is sent to an external equipment.

5. The vehicle information acquisition device according to claim 1, wherein the vehicle information acquisition device is integrated with a display means that can display the vehicle information and sends the acquired vehicle information to the display means.

6. A vehicle information acquisition method for sending a plurality of request data in a predetermined order each requesting any one of a plurality of vehicle information through a vehicle diagnosis connector provided in a vehicle and receiving a plurality of response data giving the respective types of vehicle information from the vehicle-side, thereby periodically acquiring the respective types of vehicle information,
wherein, among the plurality of request data, the request data that requests vehicle information having a higher update priority is sent more frequently than the request data that requests vehicle information having a lower update priority.

7. The vehicle information acquisition method according to claim 6, wherein, when the response data is received or when a predetermined time has elapsed since the sending of the request data, the next request data is sent.

8. The vehicle information acquisition method according to claim 6, wherein the update priorities can be switched.

9. The vehicle information acquisition method according to claim 6, wherein the acquired vehicle information is sent to an external equipment.
